(19) United States
(12) Patent Application Publication
(10) Pub. No.: US 2011/0015826 A1
(43) Pub. Date: Jan. 20, 2011

(54) VEHICLE AIR-CONDITIONING SYSTEM PROVIDED WITH AUTOMATIC MODES

(75) Inventors: Christophe Ripoll, Viroflay (FR); Nicolas Deniaud, Saint Germain de la Grange (FR); Patrick Bonniere, Vernon (FR); David Navarro, Saint- Cloud (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: RENAULT S.A.S., Boulogne Billancourt (FR)

(21) Appl. No.: 12/682,072

(22) PCT Filed: Oct. 3, 2008
(86) PCT No.: PCT/FR08/51793

§ 371 Date: Aug. 25, 2010

(30) Foreign Application Priority Data
Oct. 8, 2007 (FR) 0707056

(51) Int. Cl. G06F 19/00

(52) U.S. Cl. 701/36

(57) ABSTRACT

The invention relates to a vehicle air-conditioning system (10) capable of operating with n predetermined automatic regulation modes, the system comprising a calculator (1) capable of determining, as a function of a selected automatic mode (MODS), a blown-air temperature value (Q_{AS}), a ventilation flow rate value (DEB) and a distribution control value (REP) in order to control a heating, ventilation and air-conditioning (HVAC) unit (2) capable of regulating the temperature (Q_{HAB}) inside a passenger compartment (3) towards a setpoint temperature (θ_{c}), characterized in that the blown-air temperature value (Q_{AS}) for the selected automatic mode (MODS) that is applied to the HVAC (2) is determined as a function of the ventilation flow rate value of the selected mode (DEB_{MODS}), of a thermal power value for the selected automatic mode (P_{MODS}), and of a heat exchange coefficient value (C_{ECH}).

The invention relates to an air-conditioning system for a vehicle, able to operate in n predetermined automatic control modes, the system comprising a computer able to determine, as a function of a selected automatic mode, a blown-air temperature value, a ventilation flow rate value and a distribution control value to control a heating, ventilation and air-conditioning HVAC unit able to regulate the temperature inside a passenger compartment toward a set point temperature.

Air-conditioning is tending to become widespread in present-day vehicles, especially the air-conditioning of the so-called “regulated” type which allows the user to set a desired comfort level by entering a set point value to an air-conditioning unit control module, the system then automatically setting itself the task of regulating the temperature, the flow rate and the distribution of the blown air in order rapidly to reach the demanded comfort set point and then maintain it.

This automatic mode does have disadvantages; certain groups of occupants consider that the system often discharges a blown air flow rate that is considered to be too high and too cold onto their faces and prevents them from comfortably having a conversation in the first few minutes following a significant change in set point. These occupants therefore switch back to manual mode where they, for example, define a level of ventilation and of distribution, until such point as the temperature in the passenger compartment nears the set point, then they reengage automatic mode in order to maintain this temperature, thus losing the benefit of the automatic mode.

In addition, the difficulties in satisfying the users may be exacerbated by changes in climate. Specifically, an automatic mode suited to one climate may prove ill suited to another, and this may give rise to development problems for vehicles intended to be used in different climates.

It is an object of the invention to improve the aforementioned systems of the prior art and to address the disadvantages thereof, and in particular to provide temperature regulation in an enclosed space, for example in the passenger compartment of a vehicle, that can be performed according to several automatic modes that can be actuated directly by an occupant from the instrument panel, for example using a button.

One object of the present invention is to propose an air-conditioning system in accordance with the abovementioned preamble, in which the blown-air temperature value for the selected automatic mode supplied to the HVAC is determined as a function of the ventilation flow rate value for the selected mode, of a thermal power value for the selected automatic mode and of a heat exchange coefficient value.

This air-conditioning system makes it possible to propose automatic modes in which the levels of flow rate and of distribution differ in order to achieve a comfortable temperature such that it can be adapted to suit the user or the external conditions.

According to some particular embodiments, the air-conditioning system has one or more of the following features:
the thermal power value for the selected mode is determined as a function of the thermal power value for a reference mode and an adaptation power value for adapting with respect to this reference mode;
the adaptation power value is determined as a function of at least one difference in ventilation flow rate with respect to the reference mode and of an external temperature;
the heat exchange coefficient value is chosen from a table containing heat exchange coefficient values as a function of ventilation flow rate;
the system comprises one ventilation flow rate table per automatic mode;
the thermal power value for the reference mode is taken from a look-up table that is the same for all n automatic modes and that corresponds to the look-up table for the reference mode;
the adaptation power value for the selected mode is taken from a look-up table as a function at least of the ventilation flow rate.

Other features and advantages of the invention will become clearly apparent from reading the following description of the nonlimiting embodiment thereof, in conjunction with the figures that follow which depict one embodiment according to the invention:

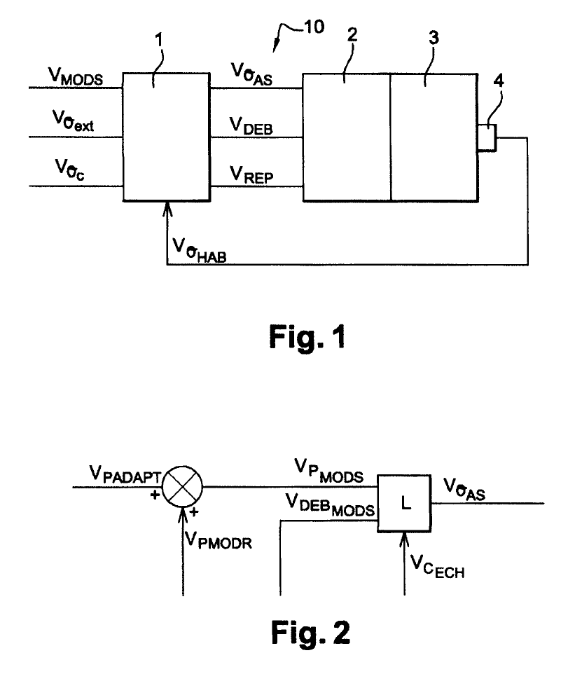

FIG. 1 depicts a block diagram of the loop that regulates the temperature in the passenger compartment of a vehicle according to the invention;

FIG. 2 details, in the form of a block diagram, how the blown air temperature value is determined.

In the description that follows, it must be understood that the signal SVx is the signal representing the physical value Vx. Moreover, for reasons of simplification, the description will be confined to a system comprising three different automatic modes, but is not in any way limited thereto, the system being applicable to at least two automatic modes.

An automatic air-conditioning system 10 is depicted in FIG. 1. This comprises an air-conditioning computer 1 controlling a heating, ventilation and air-conditioning (HVAC) unit 2, this unit allowing the temperature in the passenger compartment 3 of a motor vehicle to be varied by altering the position of blown air mixing flaps and the operation of the cold-generating loop as a function of parameters applied to it.

The air-conditioning computer 1 receives signals representative of the automatic mode MODS selected by the user, of a temperature set point θ_{c} and of a temperature θ_{EXT} outside the passenger compartment 3. A temperature θ_{HAB} measured inside the passenger compartment by a passenger compartment temperature sensor 4 allows the computer 1 to ensure convergence toward the set point temperature θ_{c}.

On the basis of these signals, the air-conditioning computer 1 determines the HVAC control parameters and transfers them to the HVAC, notably to drive the air mixing flaps and the cold-generating loop. The HVAC receives, from the air-conditioning computer 1, signals representative of the blown air temperatures θ_{AS}, of the ventilation flow rate DEB and of the distribution REP suited to the automatic mode MODS selected by the user.

Other parameters may also be used by the air-conditioning computer 1 to determine the HVAC control parameters, these including, for example, the insolation received by the passenger compartment or vehicle speed values.

FIG. 2 depicts one embodiment of how the blown air temperature θ_{AS} is determined by the computer 1.

The blown-air temperature θ_{AS} is determined from a thermal power value for the selected automatic mode P_{MODS}, from a heat exchange coefficient value C_{ECH} and from a ventilation flow rate value for the selected automatic mode DEB_{MODS}. This blown-air temperature value θ_{AS} may be determined according to a predetermined control law L or alternatively from a look-up table established during development. It might be possible, for example, to use the following control law:

$${θ}_{AS} = \frac{{P}_{MODS}}{DEB} * {C}_{ECH}$$

The heat exchange coefficient C_{ECH} may either be taken to be a constant or considered to be a function of the ventilation flow rate DEB and thus consigned to a look-up table obtained during the development of the air-conditioning system 10.

The thermal power for the selected automatic mode P_{MODS} is determined as a function of the thermal power value of the reference mode P_{MODR}. For that, the air-conditioning computer 1 adds together the thermal power value for the reference automatic mode P_{MODR} and an adaptation power value P_{ADAPT} for adapting in relation to this reference mode.

The thermal power value for the reference mode P_{MODR} is obtained from a look-up table that is the same irrespective of the automatic mode MODS selected. This table has two inputs, the set point temperature θ_{c} and the external temperature θ_{EXT}, and one output giving the power value for the reference mode P_{MODR}. In order to obtain it, when the system is set to the reference mode MODR, the system looks for the power value P_{MODR} that is able to achieve the comfort criteria that satisfy the set point temperature θ_{c} desired for each external temperature θ_{EXT} value.

The computer 1 determines the adaptation power value P_{ADAPT} as a function of a difference in ventilation flow rate Δ_{DEB} for the selected mode MODS with respect to the reference mode MODR and of an external temperature θ_{EXT}. This difference in flow rate Δ_{DEB} is obtained by subtracting the ventilation flow rate value for the selected mode DEB_{MODS} from the ventilation flow rate value of the reference mode DEB_{MODR}, the values being taken from the respective look-up tables.

These ventilation flow rate DEB tables may be obtained by wind-tunnel tests during which, for a given climate, a given blown-air temperature and a given blown-air distribution, a range of blown-air flow rate values is scanned until a flow rate value is found that makes it possible to achieve the desired level of comfort and which is assessed, for example, using a thermal dummy. All of the flow rate values are found by modifying the values of the fixed parameters.

The computer 1 may obtain the adaptation power value P_{ADAPT} from a look-up table established during system development. This value may also be obtained by calculation using a predetermined law.

The look-up table will combine two inputs, the difference in ventilation flow rate Δ_{DEB} and the external temperature θ_{EXT}, with one output that gives the corresponding adaptation power P_{ADAPT}.

This look-up table is obtained by scanning through the various automatic modes and external temperatures θ_{EXT}. An automatic mode different from the reference mode MODR is selected, and a ventilation flow rate difference value Δ_{DEB} is deduced from this. This then gives the adaptation power P_{ADAPT} that will allow the desired comfort value to be achieved. This operation is performed for the other automatic modes then these operations are repeated for each value of external temperature θ_{EXT} to be taken into consideration.

In general, increasing the number of automatic modes entails defining as many pairs of look-up tables for the blown-air temperature θ_{AS} and the ventilation flow rate DEB, in other words, if the number of automatic modes is n, that implies having 2ⁿ look-up tables.

According to the invention, for a number n of automatic modes, it is sufficient to have n look-up tables for the ventilation flow rate DEB and one table for the thermal power of the reference mode P_{MODR} and one table for the adaptation power P_{ADAPT}, namely n+2 look-up tables, and one control law L and one heat exchange coefficient C_{ECH}.

The memory capacity of the computer 1 can therefore be reduced and air-conditioning system development simplified. This proves to be all the more beneficial since air-conditioning systems need to be adapted to suit an increasingly high number of users and of climates, leading to a substantial increase in the number of automatic modes.

1. An air-conditioning system (10) for a vehicle, able to operate in n predetermined automatic control modes, the system comprising a computer (1) able to determine, as a function of a selected automatic mode (MODS), a blown-air temperature value (θ_{AS}), a ventilation flow rate value (DEB) and a distribution control value (REP) to control a heating, ventilation and air-conditioning (HVAC) unit (2) able to regulate the temperature (θ_{HAB}) inside a passenger compartment (3) toward a set point temperature (θc), characterized in that the blown-air temperature value (θ_{AS}) for the selected automatic mode (MODS) supplied to the HVAC (2) is determined as a function of the ventilation flow rate value for the selected mode (DEB_{MODS}), of a thermal power value for the selected automatic mode (P_{MODS}) and of a heat exchange coefficient value (C_{ECH}).

2. The air-conditioning system (10) as claimed in the preceding claim, characterized in that the thermal power value for the selected mode (P_{MODS}) is determined as a function of the thermal power value for a reference mode (P_{MODR}) and an adaptation power value (P_{ADAPT}) for adapting with respect to this reference mode.

3. The air-conditioning system (10) as claimed in the preceding claim, characterized in that the adaptation power value (P_{ADAPT}) is determined as a function of at least one difference in ventilation flow rate (Δ_{DEB}) with respect to the reference mode and of an external temperature (θ_{EXT}).

4. The air-conditioning system (10) as claimed in one of the preceding claims, characterized in that the heat exchange coefficient value (C_{ECH}) is chosen from a table containing heat exchange coefficient values as a function of ventilation flow rate (DEB).

5. The air-conditioning system (10) as claimed in one of the preceding claims, characterized in that it comprises one ventilation flow rate table (DEB) per automatic mode.

6. The air-conditioning system (10) as claimed in one of claims 2 to 5, characterized in that the thermal power value for the reference mode (P_{MODR}) is taken from a look-up table that is the same for all n automatic modes and that corresponds to the look-up table for the reference mode (MODR).

7. The air-conditioning system (10) as claimed in one of claims 2 to 6, characterized in that the adaptation power value for the selected mode (P_{ADAPT}) is taken from a look-up table as a function at least of the ventilation flow rate (DEB).
